(19) United States
(12) Patent Application Publication
(10) Pub. No.: US 2024/0021841 A1
(43) Pub. Date: Jan. 18, 2024

(54) Current Collector Sheet For Lead-Acid Storage Battery, Lead-Acid Storage Battery, And Bipolar Lead-Acid Storage Battery

(71) Applicants: The Furukawa Battery Co., Ltd., Yokohama (JP); Furukawa Electric Co., Ltd., Tokyo (JP)

(72) Inventors: Ayano Koide, Iwaki (JP); Keizo Yamada, Iwaki (JP); Atsushi Sato, Iwaki (JP); Hiroshi Kaneko, Tokyo (JP); Yoshiaki Ogiwara, Tokyo (JP)

(21) Appl. No.: 18/473,882

(22) Filed: Sep. 25, 2023

Related U.S. Application Data
(63) Continuation of application No. PCT/JP2022/011330, filed on Mar. 14, 2022.

(30) Foreign Application Priority Data
Mar. 26, 2021 (JP) 2021-053772

(51) Int. Cl. H01M 4/68; H01M 10/18; H01M 50/209; H01M 50/291; H01M 50/51

(52) U.S. Cl. CPC H01M 4/685; H01M 10/18; H01M 50/209; H01M 50/291; H01M 50/51; H01M 2004/028

(57) ABSTRACT

A positive electrode current collector plate, which is a current collector sheet for a lead-acid storage battery, includes a rolled sheet including a lead alloy in which a content ratio of tin (Sn) is between 1.0 mass % and 1.9 mass %, inclusive, a content ratio of calcium (Ca) is between 0.005 mass % and 0.028 mass %, inclusive, and a balance is lead (Pb) and inevitable impurities. A hole penetrating in a plate surface direction is not formed, and the number of crystal grains having a grain size of 10 μm or more present in a range excluding top and bottom 10% in a thickness direction of the rolled sheet in an arbitrary cross section is between 25 and 55, inclusive, per area of 1 mm² in the range.

### CROSS-REFERENCE TO RELATED APPLICATION(S)

This application is a Continuation of PCT Application No. PCT/JP2022/011330, filed on Mar. 14, 2022, and claims the priority of Japanese Patent Application No. 2021-053772, filed on Mar. 26, 2021, the content of which are incorporated herein by reference.

### TECHNICAL FIELD

The present invention relates to a current collector sheet for a lead-acid storage battery, a lead-acid storage battery, and a bipolar lead-acid storage battery.

### BACKGROUND

In recent years, the number of power generation facilities using natural energy such as sunlight and wind power has increased. In such power generation facilities, because the power generation amount cannot be controlled, the power load is leveled by using a storage battery. That is, when the amount of power generation is larger than a consumption, a difference is charged into the storage battery, and when the amount of power generation is smaller than a consumption, a difference is discharged from the storage battery. As the storage battery described above, a lead-acid storage battery is frequently used from the viewpoint of economic efficiency, safety, and the like. As such a conventional lead-acid storage battery, for example, a bipolar lead-acid storage battery described in JP Patent Publication No. 6124894 B2 is known.

The bipolar lead-acid storage battery has a frame shape and has a resin substrate attached to the inside of a resin frame. Lead layers are arranged on both surfaces of the substrate. A positive active material layer is adjacent to the lead layer formed on one surface of the substrate, and a negative active material layer is adjacent to the lead layer formed on the other surface of the substrate. In addition, a resin spacer having a frame shape is provided, and a glass mat impregnated with an electrolytic solution is provided inside the spacer. A plurality of frames and spacers are alternately stacked, and the frames and the spacers are bonded to each other with an adhesive or the like. In addition, the lead layers formed on both surfaces of the substrate are connected via a through-hole provided in the substrate.

That is, the bipolar lead-acid storage battery described in JP Patent Publication No. 6124894 B2 includes a plurality of cell members each including a positive electrode including a positive electrode current collector plate and a positive active material layer, a negative electrode including a negative electrode current collector plate and a negative active material layer, and a separator (e.g., a glass mat) interposed between the positive electrode and the negative electrode, the plurality of cell members being arranged in a stack manner with intervals, and a plurality of space forming members each forming a plurality of spaces for individually housing the plurality of cell members. In addition, the space forming member includes a substrate that covers at least one of a side of the positive electrode and a side of the negative electrode of the cell member, and a frame body (i.e., a frame portion and a spacer of a bipolar plate and an end plate) that surrounds a side surface of the cell member. In addition, the cell member and the substrate of the space forming member are alternately arranged in a stack state, the cell members are electrically connected in series, and frame bodies adjacent to each other are joined to each other.

JP Patent Publication No. 6124894 B2 describes the use of a lead foil as a lead layer arranged on both surfaces of a substrate but does not describe what kind of composition is specifically used as the lead foil.

Regarding a composition of a lead alloy for a current collector plate of a general lead-acid storage battery, for example, JP Patent Publication No. 5399272 B2 describes the following. Because early lead-calcium alloys usually have a relatively high content ratio (for example, 0.08% or more) of calcium and a relatively low content ratio (for example, 0.35 to 0.5%) of tin, positive electrode grids produced from these alloys have an advantage of being rapidly hardened and easily handled and pasted onto plates, but Pb₃Ca precipitates formed on top of Sn₃Ca precipitates tend to harden the alloy and tend to lead to increased corrosion and growth of the positive electrode grids in high temperature applications. In addition, a lead alloy generally used as an alloy for a grid and having a significantly low content ratio of calcium (0.02 to 0.05%) is significantly soft, is difficult to handle, and is significantly slowly hardened. Lead alloys having a significantly low calcium content ratio usually contain a relatively low amount of tin and a relatively high amount of silver, and these alloys tend to have high corrosion resistance, but these alloys are difficult to handle and require a special treatment for making a thin current collector plate (i.e., a current collector sheet), which are problems.

JP Patent Publication No. 4148175 B2 describes that a Pb—Ca—Sn-based alloy is inherently coarse in crystal grains, and thus easily undergoes grain boundary corrosion when used in a positive electrode current collector, undergoes anode oxidation in a high-temperature environment, and causes elongation of an electrode plate and deformation of a grid. As a result, contact between the grid and an active material is deteriorated, and there is a problem that battery performance is deteriorated.

In addition, JP Patent Publication No. 4148175 B2 describes that by adding Sr to a Pb—Sn alloy, a cast structure and a recrystallized structure of a rolled material are refined to suppress grain boundary corrosion and by further adding Ca, Ba, and Te, hardness of the Pb—Sn alloy can be widely adjusted. Therefore by using a rolled sheet of a lead alloy in which Sr (in addition, Ca, Ba, and Te) is added to the Pb—Sn alloy, in which at least a part of the rolled structure has a recrystallized structure having an average grain size of 20 μm or less, for a positive electrode current collector for a lead-acid storage battery, corrosion resistance is greatly improved, and it is possible to extend the life and improve the reliability of lead-acid batteries for a wide range of uses.

### SUMMARY

One of the causes of deterioration of the lead-acid storage battery is corrosion of the positive electrode current collector plate. As the battery use period becomes longer, corrosion of the positive electrode current collector plate progresses. When corrosion progresses, the positive active material cannot be held, and the performance as a battery is deteriorated. In addition, in a case where a positive electrode material (e.g., a positive electrode current collector plate or a positive active material) dropped due to corrosion comes into contact with the negative electrode, a short circuit may occur.

In particular, in a case of a bipolar lead-acid storage battery, because a current distribution is a reaction on the surface, there is no need to consider charge transfer resistance, and it is possible to thin the current collector plate. However, because a distance between the positive electrode and the negative electrode is short, there is a risk that a fatal defect occurs when the corrosion of the positive electrode current collector plate is large, and it is required to suppress the corrosion of the positive electrode current collector plate.

An object of the present invention is to provide a current collector sheet for a lead-acid storage battery that is composed of a heat treatment material of a rolled sheet made of a Pb—Ca—Sn-based alloy that does not contain Sr (which may contain Sr as inevitable impurities but does not contain Sr as a component) and that is excellent in corrosion resistance.

A first aspect of the present invention for solving the above-described problems is a current collector sheet for a lead-acid storage battery. The current collector sheet includes a rolled sheet including a lead alloy in which a content ratio of tin (Sn) is 1.0 mass % or more and 1.9 mass % or less, a content ratio of calcium (Ca) is 0.005 mass % or more and 0.028 mass % or less, and a balance is lead (Pb) and inevitable impurities, and a hole penetrating in a plate surface direction is not formed. The number of crystal grains having a grain size of 10 μm or more present in a range excluding top and bottom 10% in a thickness direction of the rolled sheet in an arbitrary cross section is 25 or more and 55 or less per area of 1 mm² in the range.

A second aspect of the present invention is a current collector sheet for a lead-acid storage battery. The current collector sheet includes a rolled sheet including a lead alloy in which a content ratio of tin (Sn) is 1.0 mass % or more and 1.5 mass % or less, a content ratio of calcium (Ca) is 0.005 mass % or more and 0.026 mass % or less, and a balance is lead (Pb) and inevitable impurities, and a hole penetrating in a plate surface direction is not formed. The number of crystal grains having a grain size of 10 μm or more present in a range excluding top and bottom 10% in a thickness direction of the rolled sheet in an arbitrary cross section is 25 or more and 40 or less per area of 1 mm² in the range.

### BRIEF DESCRIPTION OF THE DRAWINGS

FIG. 1 is a cross-sectional view illustrating a schematic configuration of a bipolar lead-acid storage battery according to an embodiment of the present invention.

FIG. 2 is a partially enlarged view of the bipolar lead-acid storage battery of FIG. 1.

FIG. 3 is a micrograph depicting a metallic structure of a cross section of the lead alloy sheet No. 1.

FIG. 4 is a micrograph depicting a metallic structure of a cross section of the lead alloy sheet No. 4.

FIG. 5 is a micrograph depicting a metallic structure of a cross section of the lead alloy sheet No. 5.

FIG. 6 is a micrograph depicting a metallic structure of a cross section of the lead alloy sheet No. 6.

FIG. 7 is a micrograph depicting a metallic structure of a cross section of the lead alloy sheet No. 7.

### DETAILED DESCRIPTION

Hereinafter, embodiments of the present invention will be described, but the present invention is not limited to the following embodiments. In the embodiments described below, technically preferable limitations are made to implement the present invention, but no limitation is an essential requirement of the present invention.

### Overall Configuration

First, an overall configuration of a bipolar lead-acid storage battery of the embodiment will be described.

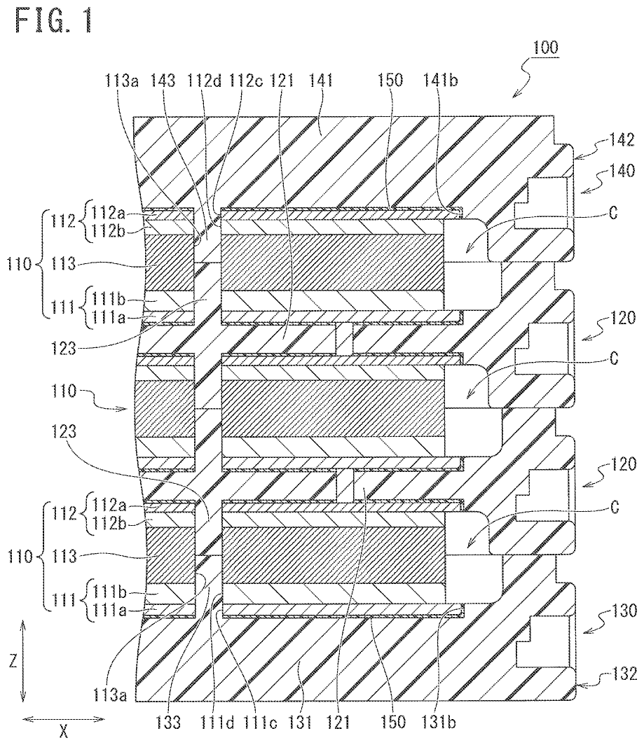

As illustrated in FIG. 1, a bipolar lead-acid storage battery 100 of the embodiment includes a plurality of cell members 110, a plurality of biplates 120 (as space forming members), a first end plate 130 (as a space forming member), and a second end plate 140 (as a space forming member). FIG. 1 illustrates the bipolar lead-acid storage battery 100 in which three cell members 110 are stacked, but the number of cell members 110 is determined by battery design. In addition, the number of the biplates 120 is determined according to the number of the cell members 110.

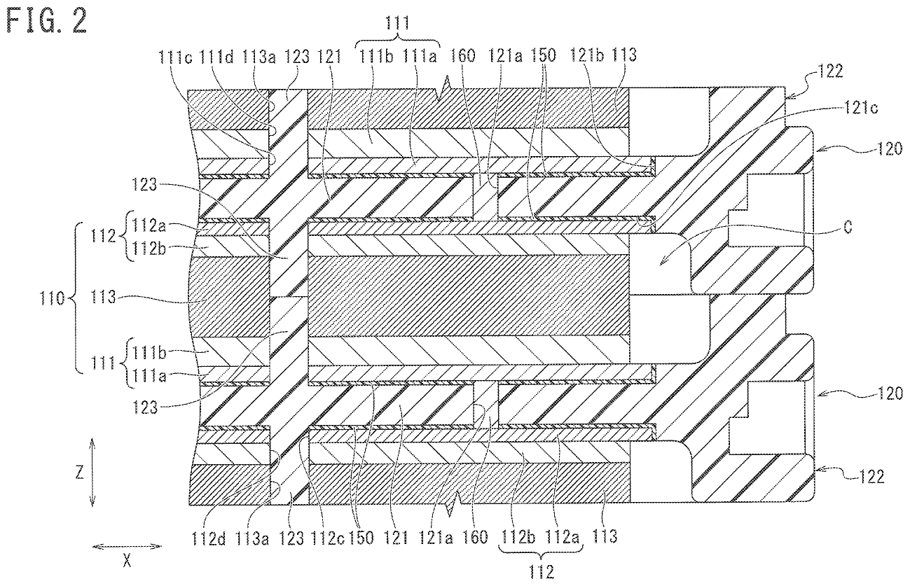

A stacking direction of the cell members 110 is defined as a Z direction (vertical direction in FIG. 1 and FIG. 2), and a direction perpendicular to the Z direction is defined as an X direction.

The cell member 110 includes a positive electrode 111, a negative electrode 112, and a separator 113 (also called an electrolyte layer). The separator 113 is impregnated with an electrolytic solution. The positive electrode 111 includes a positive electrode lead foil 111a (i.e., a positive electrode current collector plate) and a positive active material layer 111b. The negative electrode 112 includes a negative electrode lead foil 112a (i.e., a negative electrode current collector plate) and a negative active material layer 112b. The separator 113 is interposed between the positive electrode 111 and the negative electrode 112. In the cell member 110, the positive electrode lead foil 111a, the positive active material layer 111b, the separator 113, the negative active material layer 112b, and the negative electrode lead foil 112a are stacked in this order.

A dimension (e.g., a thickness) in the Z direction is larger (thicker) in the positive electrode lead foil 111a than in the negative electrode lead foil 112a, and the dimension is larger (thicker) in the positive active material layer 111b than in the negative active material layer 112b.

The plurality of cell members 110 are arranged in a stack manner with intervals in the Z direction, and a substrate 121 of the biplate 120 is arranged at the interval. That is, the plurality of cell members 110 are stacked with the substrate 121 of the biplate 120 interposed therebetween.

The plurality of biplates 120, the first end plate 130, and the second end plate 140 are members for forming a plurality of spaces C (also called cells) for individually housing the plurality of cell members 110.

As illustrated in FIG. 2, the biplate 120 includes a substrate 121 having a rectangular planar shape, a frame body 122 covering four end surfaces of the substrate 121, and column portions 123 vertically protruding from both surfaces of the substrate 121. The substrate 121, the frame body 122, and the column portions 123 are integrally formed of a synthetic resin. Note that the number of column portions 123 protruding from each surface of the substrate 121 may be one or plural.

In the Z direction, a dimension of the frame body 122 is larger than a dimension (e.g., a thickness) of the substrate 121, and a dimension between protruding end surfaces of the column portions 123 is the same as the dimension of the frame body 122. A space C is formed between the substrate 121 and the substrate 121 by stacking the plurality of biplates 120 in contact with the frame body 122 and the column portions 123. A dimension of the space C in the Z direction is maintained by the column portions 123 that are in contact with each other.

Through-holes 111c, 111d, 112c, 112d, and 113a penetrating the column portion 123 are formed in the positive electrode lead foil 111a, the positive active material layer 111b, the negative electrode lead foil 112a, the negative active material layer 112b, and the separator 113, respectively.

A substrate 121 of the biplate 120 has a plurality of through-holes 121a penetrating the plate surface. A first recess 121b is formed on one surface of the substrate 121, and a second recess 121c is formed on the other surface of the substrate 121. A depth of the first recess 121b is deeper than that of the second recess 121c. Dimensions of the first recess 121b and the second recess 121c in the X direction and the Y direction correspond to the dimensions of the positive electrode lead foil 111a and the negative electrode lead foil 112a in the X direction and the Y direction.

The substrate 121 of the biplate 120 is arranged between the cell members 110 adjacent to each other in the Z direction. The positive electrode lead foil 111a of the cell member 110 is arranged in the first recess 121b of the substrate 121 of the biplate 120 with an adhesive layer 150 interposed therebetween.

In addition, the negative electrode lead foil 112a of the cell member 110 is arranged in the second recess 121c of the substrate 121 of the biplate 120 with the adhesive layer 150 interposed therebetween.

An electrical conductor 160 is arranged in the through-hole 121a of the substrate 121 of the biplate 120, and both end surfaces of the electrical conductor 160 are in contact with and coupled to the positive electrode lead foil 111a and the negative electrode lead foil 112a. That is, the positive electrode lead foil 111a and the negative electrode lead foil 112a are electrically connected by the electrical conductor 160. As a result, all of the plurality of cell members 110 are electrically connected in series.

As illustrated in FIG. 1, the first end plate 130 includes a substrate 131 that covers a side of the positive electrode of the cell member 110, a frame body 132 that surrounds the side surface of the cell member 110, and a column portion 133 that vertically protrudes from one surface of the substrate 131 (i.e., a surface of the biplate 120 arranged closest to the side of the positive electrode, the surface facing the substrate 121). A planar shape of the substrate 131 is rectangular, four end surfaces of the substrate 131 are covered with the frame body 132, and the substrate 131, the frame body 132, and the column portion 133 are integrally formed of a synthetic resin. Note that the number of column portions 133 protruding from one surface of the substrate 131 may be one or more but corresponds to the column portion 123 of the biplate 120 to be brought into contact with the column portion 133.

In the Z direction, a dimension of the frame body 132 is larger than a dimension (e.g., a thickness) of the substrate 131, and a dimension between protruding end surfaces of the column portion 133 is the same as the dimension of the frame body 132. A space C is formed between the substrate 121 of the biplate 120 and the substrate 131 of the first end plate 130 by stacking the frame body 132 and the column portion 133 in contact with the frame body 122 and the column portion 123 of the biplate 120 arranged on the outermost side (i.e., the positive electrode side). A dimension of the space C in the Z direction is maintained by the column portion 123 of the biplate 120 and the column portion 133 of the first end plate 130, which are in contact with each other.

Through-holes 111c, 111d, and 113a penetrating the column portion 133 are formed in the positive electrode lead foil 111a, the positive active material layer 111b, and the separator 113 of the cell member 110 arranged on the outermost side (i.e., the positive electrode side), respectively.

A recess 131b is formed on one surface of the substrate 131 of the first end plate 130. A dimension of the recess 131b in the X direction corresponds to a dimension of the positive electrode lead foil 111a in the X direction.

The positive electrode lead foil 111a of the cell member 110 is arranged in the recess 131b of the substrate 131 of the first end plate 130 with the adhesive layer 150 interposed therebetween.

In addition, the first end plate 130 includes a positive electrode terminal electrically connected to the positive electrode lead foil 111a in the recess 131b.

The second end plate 140 includes a substrate 141 that covers the negative electrode of the cell member 110, a frame body 142 that surrounds the side surface of the cell member 110, and a column portion 143 that vertically protrudes from one surface of the substrate 141 (i.e., a surface of the biplate 120 arranged closest to the negative electrode, the surface facing the substrate 121). A planar shape of the substrate 141 is rectangular, four end surfaces of the substrate 141 are covered with the frame body 142, and the substrate 141, the frame body 142, and the column portion 143 are integrally formed of a synthetic resin. Note that the number of column portions 143 protruding from one surface of the substrate 141 may be one or more but corresponds to the column portion 123 of the biplate 120 to be brought into contact with the column portion 143.

In the Z direction, a dimension of the frame body 142 is larger than a dimension (e.g., a thickness) of the substrate 131, and a dimension between two protruding end surfaces of the column portion 143 is the same as the dimension of the frame body 142. A space C is formed between the substrate 121 of the biplate 120 and the substrate 141 of the second end plate 140 by stacking the frame body 142 and the column portion 143 in contact with the frame body 122 and the column portion 123 of the biplate 120 arranged on the outermost side (i.e., the negative electrode side). A dimension of the space C in the Z direction is maintained by the column portion 123 of the biplate 120 and the column portion 143 of the second end plate 140, which are in contact with each other.

Through-holes 112c, 112d, and 113a penetrating the column portion 143 are formed in the negative electrode lead foil 112a, the negative active material layer 112b, and the separator 113 of the cell member 110 arranged on the outermost side (i.e., the negative electrode side), respectively.

A recess 141b is formed on one surface of the substrate 141 of the second end plate 140. A dimension of the recess 141b in the X direction and the Y direction corresponds to a dimension of the negative electrode lead foil 112a in the X direction and the Y direction.

The negative electrode lead foil 112a of the cell member 110 is arranged in the recess 141b of the substrate 141 of the second end plate 140 with the adhesive layer 150 interposed therebetween.

In addition, the second end plate 140 includes a negative electrode terminal electrically connected to the negative electrode lead foil 112a in the recess 141b.

Note that, as can be seen from the above description, the biplate 120 is a space forming member including the substrate 121 that covers both a side of the positive electrode and a side of the negative electrode of the cell member 110 and the frame body 122 that surrounds the side surface of the cell member 110. The first end plate 130 is a space forming member including the substrate 131 that covers the side of the positive electrode of the cell member 110 and the frame body 132 that surrounds the side surface of the cell member 110. The second end plate 140 is a space forming member including the substrate 141 that covers the negative electrode of the cell member 110 and the frame body 142 that surrounds the side surface of the cell member 110.

### Configuration of Current Collector Plate

The thickness of the positive electrode lead foil 111a (i.e., the positive electrode current collector plate) 111a arranged in the recess 121b of the biplate 120 is less than 0.5 mm (for example, 0.1 mm or more and 0.4 mm or less). The positive electrode lead foil 111a includes a rolled sheet made of a lead alloy in which a content ratio of tin (Sn) is 1.0 mass % or more and 1.9 mass % or less, a content ratio of calcium (Ca) is 0.005 mass % or more and 0.028 mass % or less, and a balance is lead (Pb) and inevitable impurities. The number of crystal grains having a grain size of 10 μm or more present in a range excluding top and bottom 10% in a thickness direction of the rolled sheet in an arbitrary cross section is 25 or more and 55 or less per area of 1 mm² in the range. In the following description, the “number of crystal grains per area of 1 mm² in the above range, having a grain size of 10 μm or more present in the above range” is also simply referred to as “the number of crystal grains per 1 mm² in a cross section”.

The positive electrode lead foil 111a (i.e., the positive electrode current collector plate) arranged in the recess 131b of the first end plate 130 is formed of, for example, a rolled sheet having a thickness of 0.5 mm or more and 1.5 mm or less, made of the same lead alloy as that of the rolled sheet, and having the same number of crystal grains per 1 mm² in a cross section as that of the rolled sheet.

A thickness of the negative electrode lead foil 112a (i.e., the negative electrode current collector plate) arranged in the recess 121c of the biplate 120 is 0.05 mm or more and 0.3 mm or less. The alloy constituting the negative electrode lead foil 112a is, for example, a lead alloy in which a content ratio of tin (Sn) is 0.5 mass % or more and 2 mass % or less.

The negative electrode lead foil 112a (i.e., the negative electrode current collector plate) arranged in the recess 141b of the second end plate 140 has a thickness of, for example, 0.5 mm or more and 1.5 mm or less, and is formed of a lead alloy in which a content ratio of tin (Sn) is 0.5 mass % or more and 2 mass % or less.

### Action and Effect

In the bipolar lead-acid storage battery 100 of the embodiment, the positive electrode lead foil 111a (i.e., the positive electrode current collector plate) is formed of a rolled sheet made of a lead alloy in which a content ratio of tin (Sn) is 1.0 mass % or more and 1.9 mass % or less, a content ratio of calcium (Ca) is 0.005 mass % or more and 0.028 mass % or less, and a balance is lead (Pb) and inevitable impurities. The number of crystal grains per 1 mm² in a cross section is 25 or more and 55 or less. Accordingly, corrosion of the positive electrode lead foil 111a can be suppressed.

In the case of using a rolled sheet made of a lead alloy having a thickness of less than 0.5 mm, in which a content ratio of tin (Sn) is 1.0 mass % or more and 1.9 mass % or less, a content ratio of calcium (Ca) is 0.005 mass % or more and 0.028 mass % or less, and a balance is lead (Pb) and inevitable impurities, for example, the number of crystal grains per 1 mm² in a cross section can be set to 25 or more and 55 or less by subjecting the rolled sheet to a heat treatment under the conditions of a temperature of 250° C. or more and a melting point or less and a treatment time of 5 minutes or more in the air atmosphere.

The number of crystal grains per 1 mm² in the cross section is preferably 25 or more and 40 or less (i.e., between 25 and 40, inclusive). Within this range, a higher corrosion suppressing effect can be obtained. A more preferable range is 25 or more and 38 or less (i.e., between 25 and 39, inclusive), and a particularly preferable range is 25 or more and 35 or less (i.e., between 25 and 35, inclusive).

### EXAMPLES

Lead alloy sheets No. 1 to No. 15 shown below were prepared. The thickness of each lead alloy sheet was 0.35 mm.

A lead alloy sheet No. 1 was obtained by subjecting a rolled plate having a thickness of 0.4 mm and formed of a lead alloy in which a content ratio of calcium (Ca) was 0.000 mass %, a content ratio of tin (Sn) was 1.5 mass %, and a balance was lead (Pb) and unavoidable impurities to a heat treatment at 310° C. for 5 minutes in the air atmosphere.

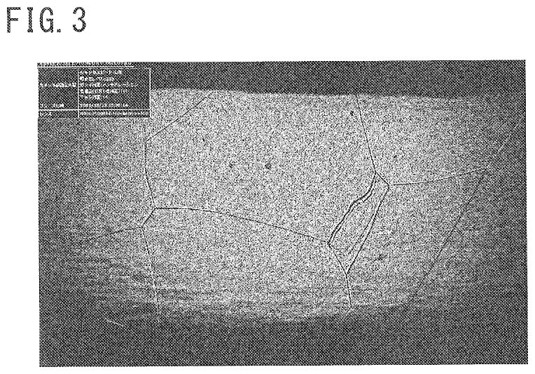

For the lead alloy sheet No. 1, a cross section perpendicular to a sheet surface and parallel to a rolling direction was imaged with an electron microscope. The micrograph is illustrated in FIG. 3.

In addition, from the image, the number of crystal grains having a grain size of 10 μm or more present in a range excluding top and bottom 10% in the thickness direction of the sheet was counted, and the number was converted into the number per area of 1 mm² in the above range in consideration of the magnification of the microscope. As a result, the number of crystal grains per 1 mm² in the cross section was 40.

A lead alloy sheet No. 2 was obtained by subjecting a rolled sheet formed of a lead alloy in which a content ratio of calcium (Ca) was 0.005 mass %, a content ratio of tin (Sn) was 1.5 mass %, and a balance was lead (Pb) and inevitable impurities to a heat treatment at 150° C. for 60 minutes in the air atmosphere. For the lead alloy sheet No. 2, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 40.

A lead alloy sheet No. 3 was obtained by subjecting a rolled sheet formed of a lead alloy in which a content ratio of calcium (Ca) was 0.010 mass %, a content ratio of tin (Sn) was 1.5 mass %, and a balance was lead (Pb) and inevitable impurities to a heat treatment at 200° C. for 30 minutes in the air atmosphere. For the lead alloy sheet No. 3, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 40.

A lead alloy sheet No. 4 was obtained by subjecting a rolled sheet formed of a lead alloy in which a content ratio of calcium (Ca) was 0.010 mass %, a content ratio of tin (Sn) was 1.5 mass %, and a balance was lead (Pb) and inevitable impurities to a heat treatment at 120° C. for 600 minutes in the air atmosphere.

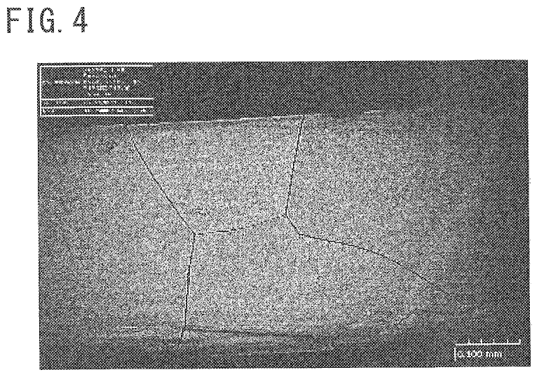

For the lead alloy sheet No. 4, a cross section perpendicular to a sheet surface and parallel to a rolling direction was imaged with an electron microscope. The micrograph is illustrated in FIG. 4. From the image, the number of crystal grains per 1 mm² in the cross section was measured in the same manner as in lead alloy sheet No. 1, and the result showed that the number of crystal grains was 25.

A lead alloy sheet No. 5 was obtained by subjecting a rolled sheet formed of a lead alloy in which a content ratio of calcium (Ca) was 0.010 mass %, a content ratio of tin (Sn) was 1.5 mass %, and a balance was lead (Pb) and inevitable impurities to a heat treatment at 60° C. for 5 minutes in the air atmosphere.

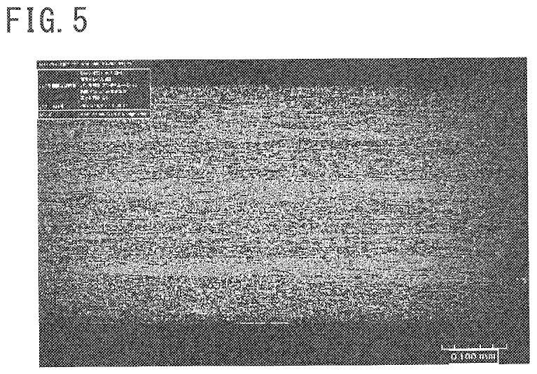

For the lead alloy sheet No. 5, a cross section perpendicular to a sheet surface and parallel to a rolling direction was imaged with an electron microscope. The micrograph is illustrated in FIG. 5. In addition, from the image, the number of crystal grains per 1 mm² in the cross section was tried to be measured by the same method as in lead alloy sheet No. 1, but the number of crystal grains could not be measured because of the striped structure.

A lead alloy sheet No. 6 was obtained by subjecting a rolled sheet formed of a lead alloy in which a content ratio of calcium (Ca) was 0.010 mass %, a content ratio of tin (Sn) was 1.5 mass %, and a balance was lead (Pb) and inevitable impurities to a heat treatment at 180° C. for 5 minutes in the air atmosphere.

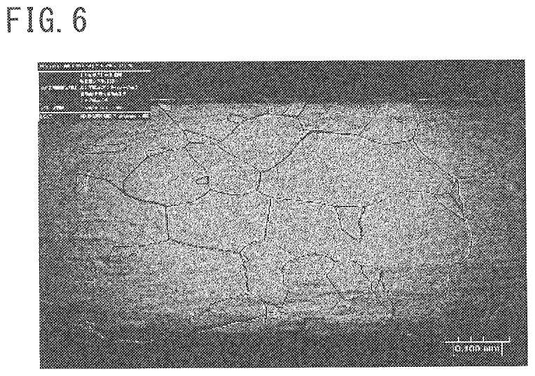

For the lead alloy sheet No. 6, a cross section perpendicular to a sheet surface and parallel to a rolling direction was imaged with an electron microscope. The micrograph is illustrated in FIG. 6. From the image, the number of crystal grains per 1 mm² in the cross section was measured in the same manner as in lead alloy sheet No. 1, and the result showed that the number of crystal grains was 135.

A lead alloy sheet No. 7 was obtained by subjecting a rolled sheet formed of a lead alloy in which a content ratio of calcium (Ca) was 0.010 mass %, a content ratio of tin (Sn) was 1.5 mass %, and a balance was lead (Pb) and inevitable impurities to a heat treatment at 220° C. for 5 minutes in the air atmosphere.

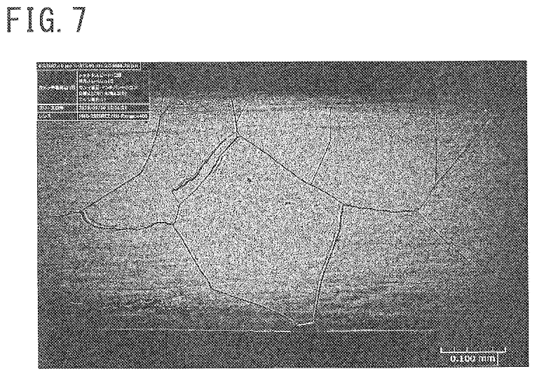

For the lead alloy sheet No. 7, a cross section perpendicular to a sheet surface and parallel to a rolling direction was imaged with an electron microscope. The micrograph is illustrated in FIG. 7. From the image, the number of crystal grains per 1 mm² in the cross section was measured in the same manner as in lead alloy sheet No. 1, and the result showed that the number of crystal grains was 60.

A lead alloy sheet No. 8 was obtained by subjecting a rolled sheet formed of a lead alloy in which a content ratio of calcium (Ca) was 0.010 mass %, a content ratio of tin (Sn) was 1.0 mass %, and a balance was lead (Pb) and inevitable impurities to a heat treatment at 220° C. for 15 minutes in the air atmosphere. For the lead alloy sheet No. 8, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 40.

A lead alloy sheet No. 9 was obtained by subjecting a rolled sheet formed of a lead alloy in which a content ratio of calcium (Ca) was 0.010 mass %, a content ratio of tin (Sn) was 2.0 mass %, and a balance was lead (Pb) and inevitable impurities to a heat treatment at 250° C. for 10 minutes in the air atmosphere. For the lead alloy sheet No. 9, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 30.

A lead alloy sheet No. 10 was obtained by subjecting a rolled sheet formed of a lead alloy in which a content ratio of calcium (Ca) was 0.010 mass %, a content ratio of tin (Sn) was mass %, and a balance was lead (Pb) and inevitable impurities to a heat treatment at 310° C. for 5 minutes in the air atmosphere. For the lead alloy sheet No. 10, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 45.

A lead alloy sheet No. 11 was obtained by subjecting a rolled sheet formed of a lead alloy in which a content ratio of calcium (Ca) was 0.026 mass %, a content ratio of tin (Sn) was 1.5 mass %, and a balance was lead (Pb) and inevitable impurities to a heat treatment at 200° C. for 200 minutes in the air atmosphere. For the lead alloy sheet No. 11, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 25.

A lead alloy sheet No. 12 was obtained by subjecting a rolled sheet formed of a lead alloy in which a content ratio of calcium (Ca) was 0.030 mass %, a content ratio of tin (Sn) was 1.5 mass %, and a balance was lead (Pb) and inevitable impurities to a heat treatment at 150° C. for 600 minutes in the air atmosphere. For the lead alloy sheet No. 12, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 25.

A lead alloy sheet No. 13 was obtained by subjecting a rolled sheet formed of a lead alloy in which a content ratio of calcium (Ca) was 0.010 mass %, a content ratio of tin (Sn) was 1.5 mass %, and a balance was lead (Pb) and inevitable impurities to a heat treatment at 150° C. for 30 minutes in the air atmosphere. For the lead alloy sheet No. 13, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 55.

A lead alloy sheet No. 14 was obtained by subjecting a rolled sheet formed of a lead alloy in which a content ratio of calcium (Ca) was 0.028 mass %, a content ratio of tin (Sn) was 1.5 mass %, and a balance was lead (Pb) and inevitable impurities to a heat treatment at 210° C. for 60 minutes in the air atmosphere. For the lead alloy sheet No. 14, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 38.

A lead alloy sheet No. 15 was obtained by subjecting a rolled sheet formed of a lead alloy in which a content ratio of calcium (Ca) was 0.010 mass %, a content ratio of tin (Sn) was 1.9 mass %, and a balance was lead (Pb) and inevitable impurities to a heat treatment at 215° C. for 60 minutes in the air atmosphere. For the lead alloy sheet No. 15, a cross section perpendicular to the sheet surface and parallel to the rolling direction was imaged with an electron microscope, and the number of crystal grains per 1 mm² in the cross section was measured in the same manner as in lead alloy sheet No. 1, and the result showed that the number of crystal grains was 30.

A corrosion test was performed on each of the lead alloy sheets Nos. 1 to 15 by the following method.

Each lead alloy sheet was cut into a test piece having a width of 15 mm and a length of 70 mm, the test piece was placed in sulfuric acid having a specific gravity of 1.28 at 60° C. and subjected to continuous anodization at a constant potential of 1,350 mV (vs: Hg/Hg₂SO₄) for 28 days, and then a product oxide was removed. The mass was measured before and after the test, a mass loss by the test was calculated from the value, and a mass loss per total surface area of the test piece was taken as a corrosive amount. In addition, a cross-sectional structure after the corrosion test was observed with an electron microscope (magnification: 400 times) to examine whether or not the lead alloy sheet had through-holes.

For each of the lead alloy sheets of No. 1 to No. 15, solder welding was performed on a part of the plate surface, the cross-sectional structure around the welded portion was then observed with an electron microscope, a cross section perpendicular to the sheet surface and parallel to the rolling direction was imaged, and the number of crystal grains per 1 mm² in the cross section was measured by the same method as in lead alloy sheet No. 1. Then, it was examined whether the number of crystal grains changed before and after welding. When the number of crystal grains changes before and after welding, there is a possibility that unintended local corrosion progresses from the connection portion by connecting the positive electrode current collector sheet and the negative electrode current collector sheet by resistance welding.

The heat treatment was performed under various conditions, but no heat treatment condition was found in which the number of crystal grains per 1 mm² in a cross section perpendicular to the sheet surface and parallel to the rolling direction was less than 25.

These results are shown in Tables 1 to 3 together with the configuration of each lead alloy sheet.

TABLE 1

| | | | | | | Test results | | |
|---|---|---|---|---|---|---|---|---|
| | Configuration of lead alloy sheet | | | | | | | Change in |
| | | Sn content | Heat treatment | | | | | number of |
| | Ca content in | in lead | condition | | Number of | | Corrosive | crystals |
| | lead alloy | alloy | Temperature | Time | grains | | amount | before/after |
| No. | (mass %) | (mass %) | (° C.) | (minute) | (grains/mm²) | Through-hole | (mg/cm²) | welding |
| 1 | 0.000 | 1.5 | 310 | 5 | 40 | Present | 30 to 50 | Absent |
| 2 | 0.005 | 1.5 | 150 | 60 | 40 | Absent | 30 or less | Absent |
| 3 | 0.010 | 1.5 | 200 | 30 | 40 | Absent | 30 or less | Absent |
| 11 | 0.026 | 1.5 | 200 | 200 | 25 | Absent | 30 or less | Absent |
| 14 | 0.028 | 1.5 | 210 | 60 | 38 | Absent | 30 or less | Absent |
| 12 | 0.030 | 1.5 | 150 | 600 | 25 | Absent | 30 to 50 | Absent |

TABLE 2

| | | | | | | Test results | | |
|---|---|---|---|---|---|---|---|---|
| | Configuration of lead alloy sheet | | | | | | | Change in |
| | | Sn content | Heat treatment | | | | | number of |
| | Ca content in | in lead | condition | | Number of | | Corrosive | crystals |
| | lead alloy | alloy | Temperature | Time | grains | | amount | before/after |
| No. | (mass %) | (mass %) | (° C.) | (minute) | (grains/mm²) | Through-hole | (mg/cm²) | welding |
| 5 | 0.010 | 1.5 | 60 | 5 | Not | Absent | Over 50 | Absent |
| | | | | | measurable | | | |
| | | | | | (Striped | | | |
| | | | | | structure) | | | |
| 4 | 0.010 | 1.5 | 120 | 600 | 25 | Absent | 30 or less | Absent |
| 3 | 0.010 | 1.5 | 200 | 30 | 40 | Absent | 30 or less | Absent |
| 13 | 0.010 | 1.5 | 150 | 30 | 55 | Absent | 30 or less | Absent |
| 7 | 0.010 | 1.5 | 220 | 5 | 60 | Absent | 30 to 50 | Present |
| 6 | 0.010 | 1.5 | 180 | 5 | 135 | Absent | Over 50 | Present |

TABLE 3

| | | | | | | Test results | | |
|---|---|---|---|---|---|---|---|---|
| | Configuration of lead alloy sheet | | | | | | | Change in |
| | | Sn content | Heat treatment | | | | | number of |
| | Ca content in | in lead | condition | | Number of | | Corrosive | crystals |
| | lead alloy | alloy | Temperature | Time | grains | | amount | before/after |
| No. | (mass %) | (mass %) | (° C.) | (minute) | (grains/mm²) | Through-hole | (mg/cm²) | welding |
| 10 | 0.010 | 0.5 | 310 | 5 | 45 | Absent | 30 to 50 | Absent |
| 8 | 0.010 | 1.0 | 220 | 15 | 40 | Absent | 30 or less | Absent |
| 3 | 0.010 | 1.5 | 200 | 30 | 40 | Absent | 30 or less | Absent |
| 15 | 0.010 | 1.9 | 215 | 60 | 30 | Absent | 30 or less | Absent |
| 9 | 0.010 | 2.0 | 250 | 10 | 30 | Present | 30 or less | Absent |

From the results in Tables 1 to 3, it can be seen that the lead alloy sheet is excellent in corrosion resistance when the lead alloy sheet is constituted of a heat treatment material of a rolled sheet made of a lead alloy in which the thickness is 0.35 mm, the content ratio of tin (Sn) is 1.0 mass % or more and 1.5 mass % or less (between 1.0 and 1.5 mass %, inclusive), the content ratio of calcium (Ca) is 0.005 mass % or more and 0.026 mass % or less (between 0.005 and 0.026 mass %, inclusive), and the balance is lead (Pb) and inevitable impurities, and the number of crystal grains (number of grains: [grains/mm²]) per 1 mm² in a cross section perpendicular to the sheet surface and parallel to the rolling direction is 25 or more and 55 or less (between 25 and 55, inclusive).

When the number of crystal grains per 1 mm² in a cross section perpendicular to the sheet surface and parallel to the rolling direction is 25 or more and 55 or less, it can be estimated that the number of crystal grains per 1 mm² is 25 or more and 55 or less in a cross section other than this cross section (e.g., an arbitrary cross section)

Table 1 is a table summarizing results for samples in which the content ratios of tin (Sn) in the lead alloys constituting the lead alloy sheets are the same at 1.5 mass % and the content ratios of calcium (Ca) are different. The number of grains (grains/mm²) in the samples summarized in Table 1 is 25 or more and 40 or less. From this table, it can be seen that when the content ratio of calcium (Ca) in the lead alloy constituting the lead alloy sheet is 0.005 mass % or more and 0.028 mass % or less, corrosion resistance can be improved, and formation of through-holes can be prevented.

Table 2 is a table summarizing the results for samples in which the content ratios of tin (Sn) in the lead alloys constituting the lead alloy sheets are the same at 1.5 mass %, the content ratios of calcium (Ca) are the same at 0.010 mass % and the numbers of grains (grains/mm²) are different by changing the heat treatment conditions. From this table, it can be seen that by setting the number of crystal grains per 1 mm² in an arbitrary cross section of the lead alloy sheet to 25 or more and 55 or less, corrosion resistance can be improved, and a change in the number of crystal grains before and after welding can be prevented.

Table 3 is a table summarizing results for samples in which the content ratios of calcium (Ca) in the lead alloys constituting the lead alloy sheets are the same at 0.010 mass % and the content ratios of tin (Sn) in the lead alloys are different. The number of grains (grains/mm²) in the samples summarized in Table 1 is 30 or more and 45 or less. From this table, it can be seen that when the content ratio of tin (Sn) in the lead alloy constituting the lead alloy sheet is 1.0 mass % or more and 1.9 mass % or less, corrosion resistance can be improved, and formation of through-holes can be prevented.

What is claimed is:

1. A current collector sheet for a lead-acid storage battery, the current collector sheet comprising:
a rolled sheet including a lead alloy in which a content ratio of tin (Sn) is 1.0 mass % or more and 1.9 mass % or less, a content ratio of calcium (Ca) is 0.005 mass % or more and 0.028 mass % or less, and a balance is lead (Pb) and inevitable impurities, and a hole penetrating in a plate surface direction is not formed,
wherein a number of crystal grains having a grain size of 10 μm or more present in a range excluding top and bottom 10% in a thickness direction of the rolled sheet in an arbitrary cross section is 25 or more and 55 or less per area of 1 mm² in the range.

2. A lead-acid storage battery comprising the current collector sheet according to claim 1.

3. A bipolar lead-acid storage battery, comprising:
a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and
a plurality of space forming members each forming a plurality of spaces for individually housing the plurality of cell members,
wherein the space forming member includes a substrate configured to cover at least one of a side of the positive electrode and a side of the negative electrode of the cell member, and a frame body configured to surround a side surface of the cell member,
the cell member and the substrate of the space forming member are arranged to be alternately stacked,
the plurality of cell members are electrically connected in series, and the frame bodies adjacent to each other are joined to each other, and
the positive electrode current collector plate is the current collector sheet according to claim 1.

4. A current collector sheet for a lead-acid storage battery, the current collector sheet comprising:
a rolled sheet including a lead alloy in which a content ratio of tin (Sn) is 1.0 mass % or more and 1.5 mass % or less, a content ratio of calcium (Ca) is 0.005 mass % or more and 0.026 mass % or less, and a balance is lead (Pb) and inevitable impurities, and a hole penetrating in a plate surface direction is not formed,
wherein a number of crystal grains having a grain size of 10 μm or more present in a range excluding top and bottom 10% in a thickness direction of the rolled sheet in an arbitrary cross section is 25 or more and 40 or less per area of 1 mm² in the range.

5. A lead-acid storage battery comprising the current collector sheet according to claim 4.

6. A bipolar lead-acid storage battery comprising:
a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and
a plurality of space forming members each forming a plurality of spaces for individually housing the plurality of cell members,
wherein the space forming member includes a substrate configured to cover at least one of a side of the positive electrode and a side of the negative electrode of the cell member, and a frame body configured to surround a side surface of the cell member,
the cell member and the substrate of the space forming member are arranged to be alternately stacked,
the plurality of cell members are electrically connected in series, and the frame bodies adjacent to each other are joined to each other, and
the positive electrode current collector plate is the current collector sheet according to claim 4.
